(19) United States
(12) Patent Application Publication
(10) Pub. No.: US 2015/0197179 A1
(43) Pub. Date: Jul. 16, 2015

(54) CLUTCH FOR ADJUSTER IN HEADLAMPS

(71) Applicant: Valeo Lighting Systems North America, LLC, Seymour, IN (US)

(72) Inventors: Robert Lee King, Seymour, IN (US); Sanders R. Brott, Seymour, IN (US)

(21) Appl. No.: 14/597,884

(22) Filed: Jan. 15, 2015

Related U.S. Application Data
(60) Provisional application No. 61/928,018, filed on Jan. 16, 2014.

(51) Int. Cl. B60Q 1/072; F16H 35/10; F16H 19/08

(52) U.S. Cl. CPC B60Q 1/072; F16H 19/08; F16H 35/10

(57) ABSTRACT

A clutch for preventing overloading of a mechanism which adjusts headlamps in a vehicle. A worm gear or driven gear is driven by a worm or driving gear mounted on a flexible shaft. The worm gear or driven gear adjusts a headlamp reflector in one embodiment. When the worm gear or driven gear reaches a limit of rotation, the flexible shaft deflects, thereby causing the worm or driving gear to disengage from the worm gear or driven gear, thereby preventing further rotation of the worm gear or driven gear and possible damage thereto or to other components of the system.

### CROSS-REFERENCE TO RELATED APPLICATIONS

The present application claims priority to provisional U.S. Application Ser. No. 61/928,018 filed Jan. 16, 2014, to which Applicant claims the benefit of the earlier filing date. The provisional application is incorporated herein by reference and made a part hereof.

### BACKGROUND OF THE INVENTION

1. Field of the Invention

The invention concerns a clutch which prevents application of excessive force to a mechanism which adjusts headlamps in a vehicle.

2. Description of the Related Art

It is occasionally necessary to adjust the headlamps of a vehicle to assure that their light beams are projected in the correct or desired directions. Mechanisms currently exist for this purpose, and these mechanisms often place limits on the range of adjustment which is possible.

However, when the headlamp arrives at its limit, that arrival may not be apparent to the person making the adjustment. The person may attempt to force the headlamp beyond the limit, thereby causing damage. To prevent this damage, mechanical clutches are often incorporated into the mechanisms to restrict the force which can be applied by the person.

The following U.S. patents and applications, which are hereby incorporated by reference, provide examples of adjustment mechanisms: 2014/0003080 (King); U.S. Pat. No. 7,975,974 (Schaefer); U.S. Pat. No. 5,530,629 (Uehara); U.S. Pat. No. 5,260,857 (Lukkarinen); U.S. Pat. No. 5,267,128 (Shamir); U.S. Pat. No. 5,214,971 (Burton); U.S. Pat. No. 7,264,376 (Burton); U.S. Pat. No. 7,150,541 (Burton); and U.S. Pat. No. 6,974,231 (Burton).

The invention proposes an improved clutch which is simple in design, manufacture and use.

### SUMMARY OF THE INVENTION

An object of one embodiment of the invention is to provide an improved mechanism for adjusting headlamps.

A further object of one embodiment of the invention is to provide a simple clutch for preventing over-stressing a headlight adjustment mechanism.

In one form of the invention, a worm gear or driven gear is driven by a worm or driving gear mounted on a flexible shaft. The worm gear or driven gear adjusts a position of the headlamp. When the worm gear or driven gear reaches a limit of rotation, the flexible shaft deflects, thereby causing the worm or driving gear to disengage from the worm gear or driven gear, thereby preventing further rotation of the worm gear or driven gear. The deflection acts as a clutch.

In one aspect, one embodiment of the invention comprises an apparatus for aiming a lighting device in a vehicle, comprising a gear which is affixed to a source of light and alters direction of the light when it rotates, and a worm or driving gear which engages the gear and causes the gear to rotate when the worm or driving gear rotates and disengages from the gear and does not cause the gear to rotate when the gear reaches a limit of rotation.

In another aspect, another embodiment of the invention comprises a vehicle lighting device adjuster which adjusts an optical axis of light projected by a light source in a vehicle lighting device comprising a worm gear or driven gear which, when rotated, alters the optical axis of light, and a worm or driving gear which rotates the worm gear or driven gear and holds the worm gear or driven gear in a selected position and acts as a clutch when the worm gear or driven gear reaches a travel limit.

In yet another aspect, another embodiment of the invention comprises a vehicle lighting device adjuster which adjusts optical axis of light projected by a light source comprising a reflector which receives the light and projects the light from a vehicle along the optical axis. an adjustment bracket which supports the reflector, a rotatable worm gear or driven gear which supports the adjustment bracket to thereby rotate the reflector when the worm gear or driven gear rotates, a worm or driving gear which drives the worm gear or driven gear, and a flexible shaft which supports the worm or driving gear and which draws the worm or driving gear out of engagement when loading imposed by the worm gear or driven gear exceeds a predetermined limit.

In still another aspect, another embodiment of the invention comprises a vehicle lighting device comprising an adjuster which adjusts an optical axis of light projected by a light source comprising a reflector which receives the light and projects the light from a vehicle along the optical axis, the adjuster comprising an adjustment housing which supports the reflector, a driven gear which drives the adjustment housing to change a position of the reflector when the driven gear rotates, a driving gear which drives the driven gear, a flexible shaft which supports the driving gear and which draws the driving gear out of engagement when loading imposed by the driven gear exceeds a predetermined limit, and at least one adjustable sealing cap detachably coupled to the adjustment housing and engaging the flexible shaft and allowing it to spin, while providing an adjustment location on the outside of the vehicle lighting device.

This invention, including all embodiments shown and described herein, could be used alone or together and/or in combination with one or more of the features covered by one or more of the claims set forth herein, including but not limited to one or more of the features or steps mentioned in the following bullet list and the claims:
The apparatus wherein the source of light comprises a reflector which receives light from an illuminator which comprises at least one light-emitting diode.
The apparatus wherein the source of light comprises an illuminator which comprises a plurality of light-emitting diodes.
The apparatus wherein the worm or driving gear is elastic and flexible.
The apparatus wherein the worm or driving gear is made of plastic.
The apparatus wherein the lighting device is a headlamp having a reflector coupled to or integral with the gear and that moves in response thereto.
The apparatus wherein the worm or driving gear is elastic and deforms to cause the disengagement from the gear.
The apparatus wherein the apparatus further comprises a support bracket for rotatably supporting the worm or driving gear in operative relationship to the gear.
The vehicle lighting device adjuster wherein the worm or driving gear acts as a clutch by deforming or being deflected out of engagement with the worm gear or driven gear.
The vehicle lighting device adjuster and further comprising a rod which supports the worm or driving gear and which bends or deforms when the worm gear or driven gear reaches the travel limit, to thereby disengage the worm or driving gear from the worm gear or driven gear.
The vehicle lighting device adjuster and further comprising a reflector attached to the worm gear or driven gear for reflecting light along the optical axis.
The vehicle lighting device adjuster wherein the worm or driving gear is elastic and flexible.
The vehicle lighting device adjuster wherein the worm or driving gear is made of plastic.
The vehicle lighting device adjuster wherein the loading exceeds the predetermined limit when the worm gear or driven gear is obstructed from further movement.
The vehicle lighting device wherein the adjustment housing comprises an aperture and the at least one adjustable sealing cap is removeably snap fit into the aperture.
The vehicle lighting device wherein the flexible shaft comprises an end that is captured in the at least one adjustable sealing cap after the at least one adjustable sealing cap is detachably securing to the adjustment housing.
The vehicle lighting device wherein the at least one adjustable sealing cap comprises a slot or aperture that allows a tool to be inserted therethrough and engage a tool-engaging end of the flexible shaft in order to rotate the driving gear which, in turn, drives the driven gear.

These and other objects and advantages of the invention will be apparent from the following description, the accompanying drawings and the appended claims.

### BRIEF DESCRIPTION OF THE ACCOMPANYING DRAWINGS

FIG. 1 illustrates one form of the invention within a generic automobile;

FIG. 2 shows one form of the invention;

FIG. 3 shows part of the invention, including a reflector which is rotated about a pivot by a worm gear or driven gear;

FIG. 4 shows, in enlarged form, the worm gear or driven gear in engagement with a worm or driving gear;

FIG. 5 shows, in enlarged form, the worm gear or driven gear of FIG. 4, but now disengaged from the worm or driving gear;

FIG. 6 shows the engagement of FIG. 4 in more detail;

FIG. 7 shows the disengagement of FIG. 5 in more detail;

FIG. 8 shows the control rod and worm or driving gear of FIG. 2;

FIG. 9 shows greater detail of one form of the invention;

FIG. 10 shows a simplified view of the housing of FIG. 2;

FIG. 11 shows the two balls of FIG. 9 mated with two sockets which connect to two reflectors;

FIG. 12 illustrates one form of the invention wherein the control rod rotates about pivot and is biased by a spring; and

FIG. 13 illustrates two spur gears and the opposing forces which are generated.

### DETAILED DESCRIPTION OF THE PREFERRED EMBODIMENTS

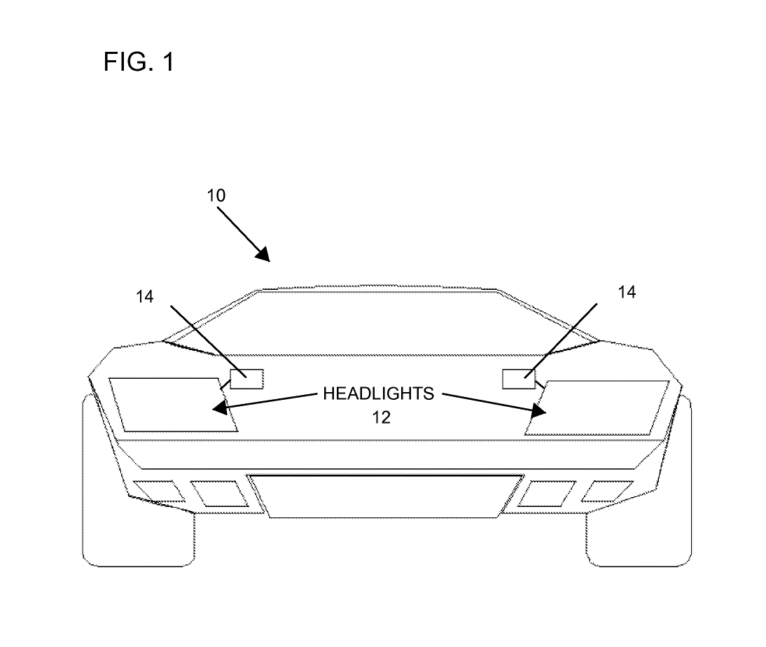

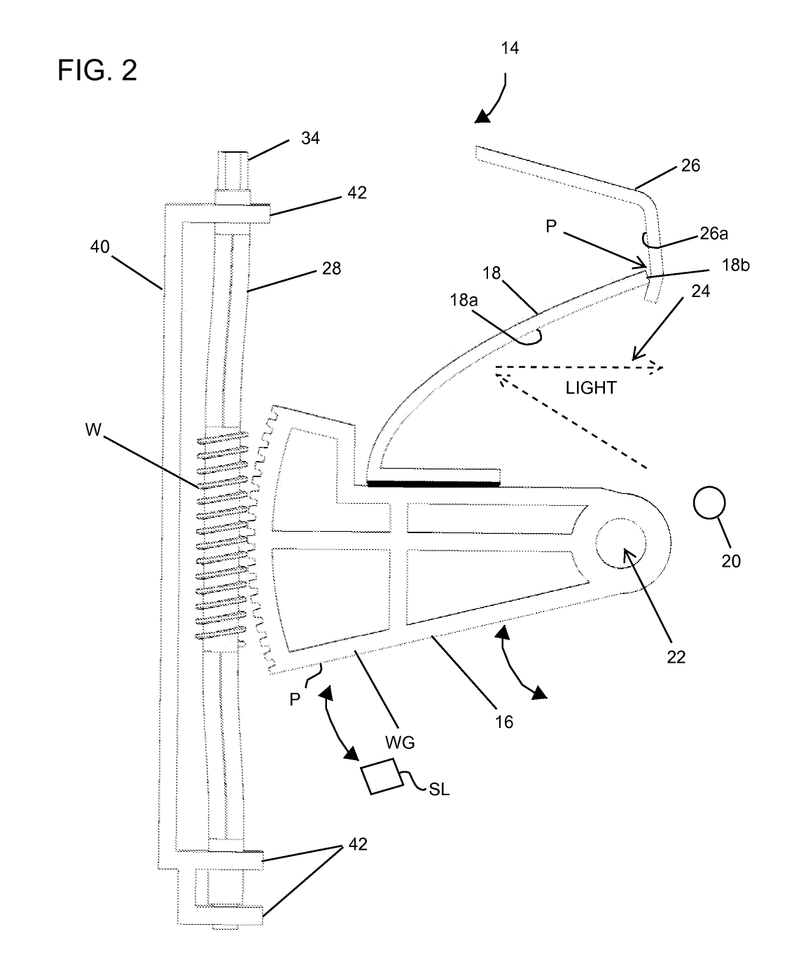

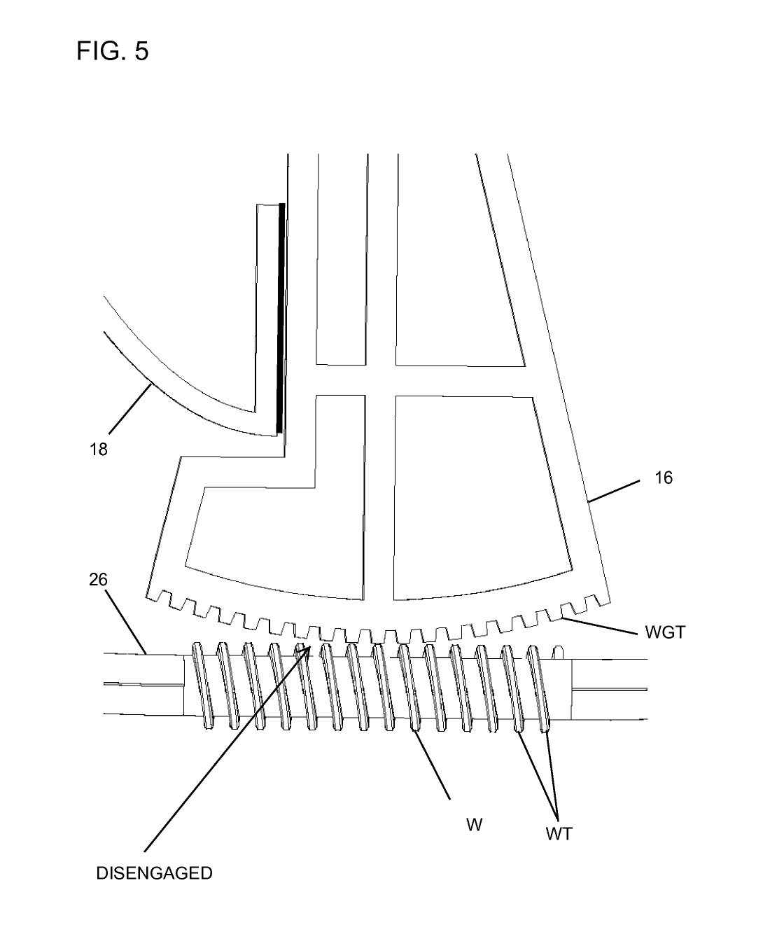

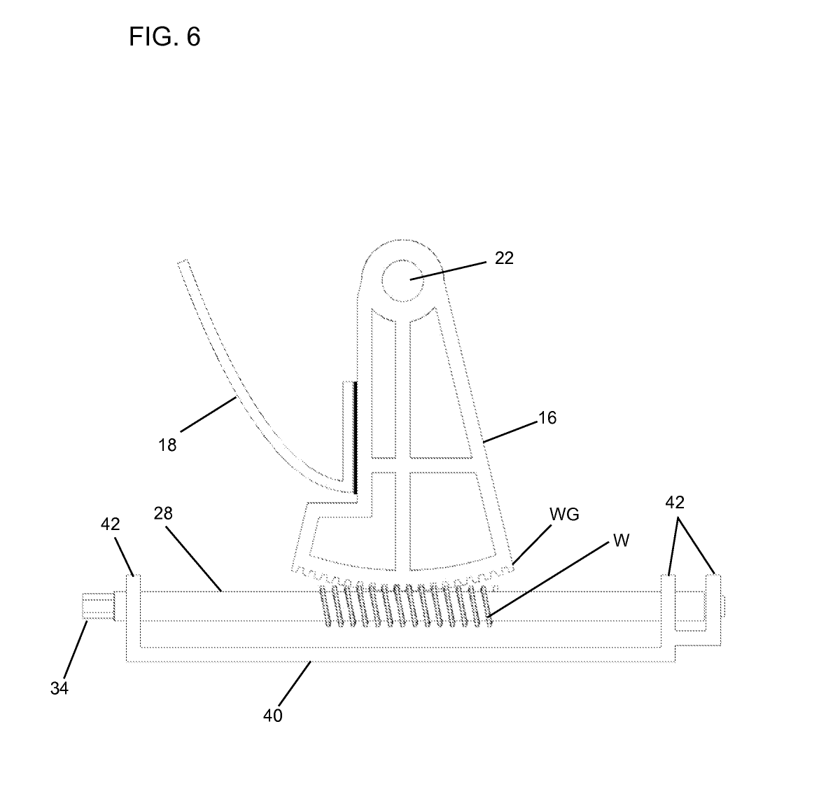

In a preferred embodiment, this invention is used to adjust headlights in motor vehicles. FIG. 1 is a frontal view of a generic motor vehicle 10 showing headlights 12. Blocks 14 schematically represent the invention which can take the form shown in FIGS. 2-11. The components of this embodiment will be explained by reference to FIGS. 2-11.

FIG. 2 shows a worm gear or driven gear WG which is integrally formed or attached to an adjustment bracket 16. A reflector 18, also shown in FIG. 2, is attached to or integrally formed in the adjustment bracket 16. As shown in FIG. 2, a reflective surface 18a of the reflector 18 reflects light received from a light source 20, which preferably comprises one or more light-emitting diodes (LEDs) incandescent lamps or halogen lamps. The combination of the reflector 18 and the light source 20 provide a lighting function, such as a headlamp, side lighting or a turning signal function of the motor vehicle 10.

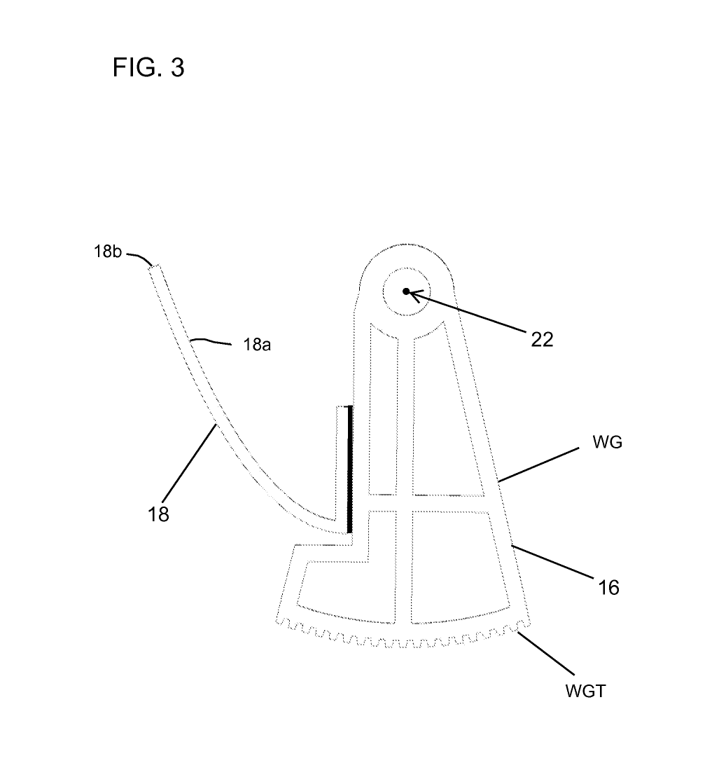

In FIGS. 2-8, the worm gear or driven gear WG, as well as the attached adjustment bracket 16 and reflector 18, rotate or pivot about a pivot axis 22 (FIG. 3). The angular position of the reflector 18 about pivot axis 22 determines the direction at which the light is reflected and thus the direction of an optical axis 24 in FIG. 2 at which the light is projected from the motor vehicle 10.

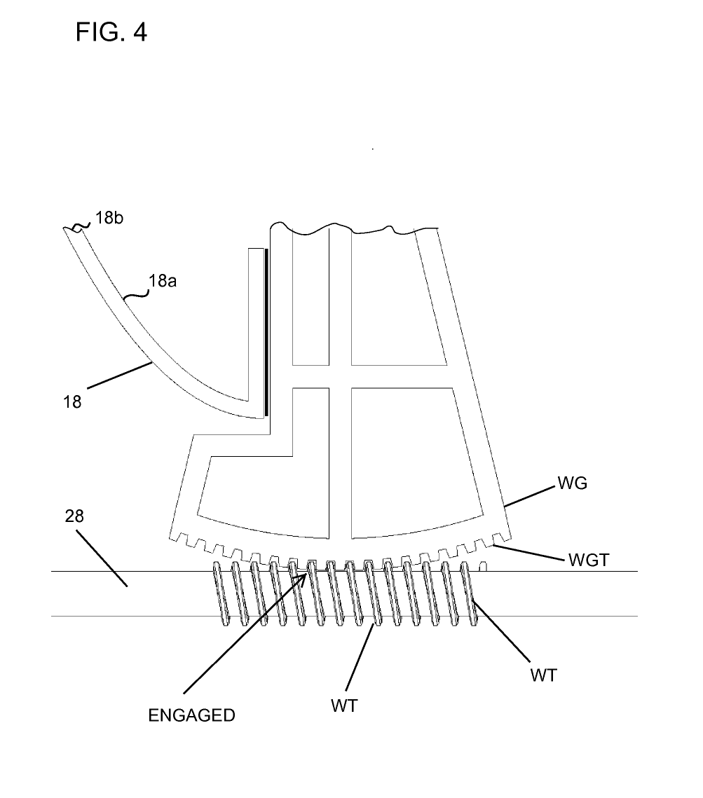

In FIGS. 4-6, a worm or driving gear W is workably engaged to and meshes with the worm gear or driven gear WG, also shown in FIG. 2. When the worm or driving gear W is rotated, the worm gear or driven gear WG and the attached adjustment bracket 16 and reflector 18 are caused to rotate or pivot about the pivot axis 22. The engagement is shown in enlarged form in FIG. 4 where the teeth WGT of the worm gear or driven gear WG mesh with the helical thread WT of the worm or driving gear W.

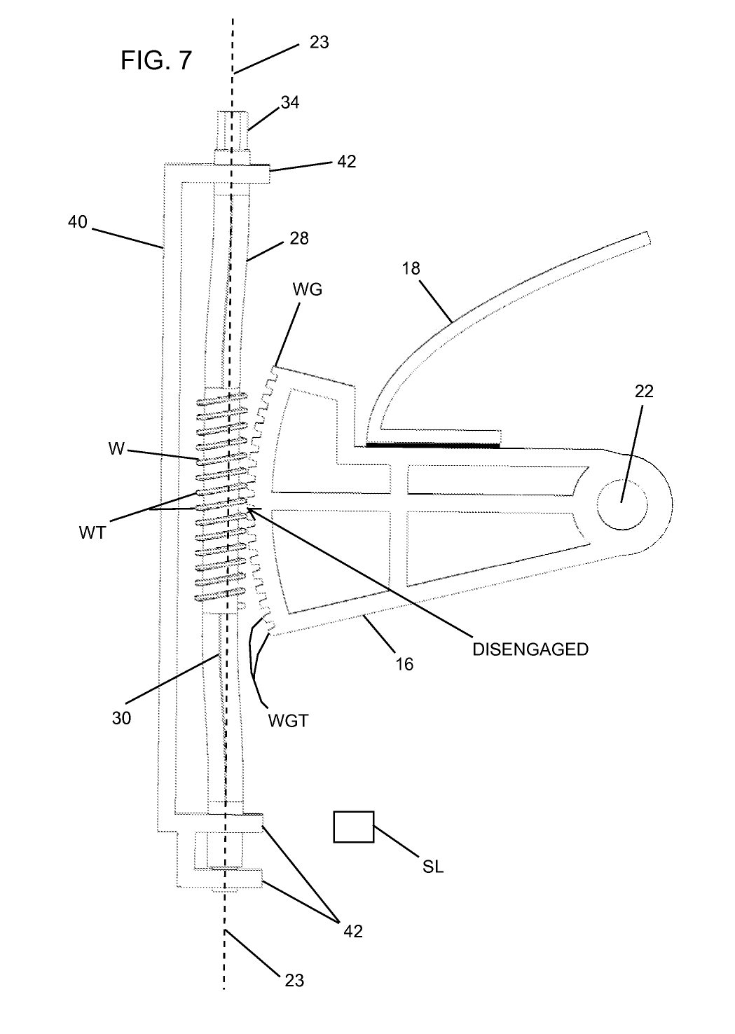

However, when the adjustment bracket 16 in FIG. 2 reaches a limit of its rotational or pivotal travel, such as when an edge or surface 18b of the reflector 18 becomes abutted against a surface 26a of a bezel 26 at point P in FIG. 2, further rotation of the adjustment bracket 16 is not possible without causing damage to some component. At this time, bending occurs in the worm W or in a control rod 28 to which worm or driving gear W is attached or integrally formed, or bending occurs in both the worm or driving gear W and the control rod 28. The worm or driving gear W becomes disengaged from the worm gear or driven gear WG, as shown in FIGS. 2, 5 and 7. The bending is indicated by the deformation of the centerline 30 of the control rod 28 relative to the axis 23 of the control rod 28 in FIG. 7.

This disengagement provides a clutching function. When the worm or driving gear W becomes disengaged from the worm gear or driven gear WG, as in FIGS. 2, 5 and 7, further rotation of the worm gear or driven gear WG about the pivot axis 22 terminates. However, if the worm or driving gear W is rotated in the opposite direction, then the worm or driving gear W will become engaged with and mesh with the worm gear or driven gear WG once more and retract the reflector 18 from the abutment point P in FIG. 2. The reengagement occurs because the flexible and elastic control rod 28 prefers to maintain its original straight, non-bent shape. In this regard, the control rod 28 and worm or driving gear W are an integral, one-piece constructions made of plastic.

Thus, rotation of the control rod 28 in one direction will cause the abutment at abutment point P in FIG. 2. At this time, further rotation will ultimately cause the disengagement shown in FIGS. 2, 5 and 7, wherein the teeth WT of the worm or driving gear W separate from the teeth WGT of the worm gear or driven gear WG. However, the control rod 28 acts as a spring at this time, biasing the worm or driving gear W against the worm gear or driven gear WG. If the control rod 28 is now rotated in the opposite direction, the teeth WT of the worm or driving gear W will again mesh with the teeth WGT of the worm gear or driven gear WG because of the spring-action of the control rod 28. The worm or driving gear W will become reengaged with the worm gear or driven gear WG.

This reengagement can be important when two limits are placed upon the reflector 18. For example, FIG. 2 shows one limit at abutment point P which limits clockwise rotation (as viewed in the FIG. 2) of the worm gear or driven gear WG. A second limit SL (FIG. 7) can be present which limits counter-clockwise rotation of the reflector 18 by engaging surface or abutment point 32 when the worm gear or driven gear WG is rotated too far. The reengagement just described allows the worm or driving gear W to cause the worm gear or driven gear WG to traverse or pivot between the two limits P and SL.

The second limit SL can be imposed by elements which are mirror images of the reflector 18 and bezel 26 in FIG. 2. These mirror images would be located below the pivot axis 22 in the FIG. 2 with the optical axis 24 acting as the “mirror”.

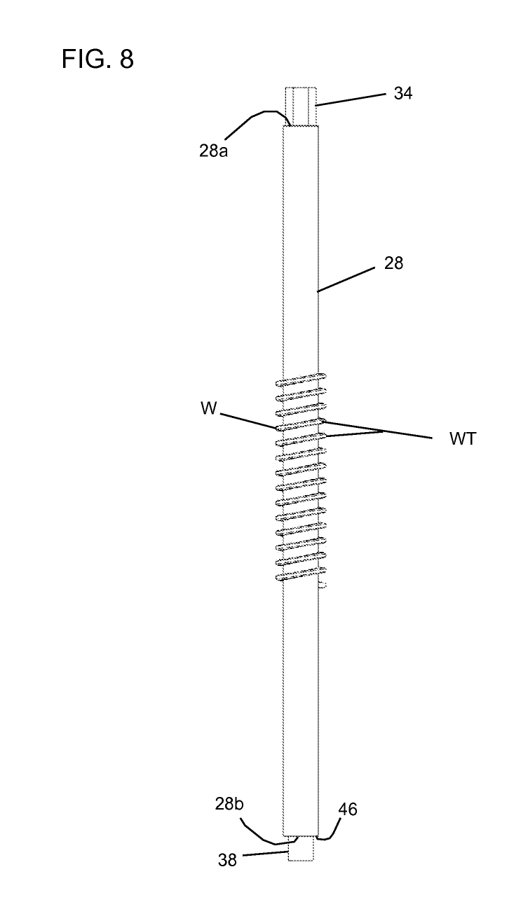

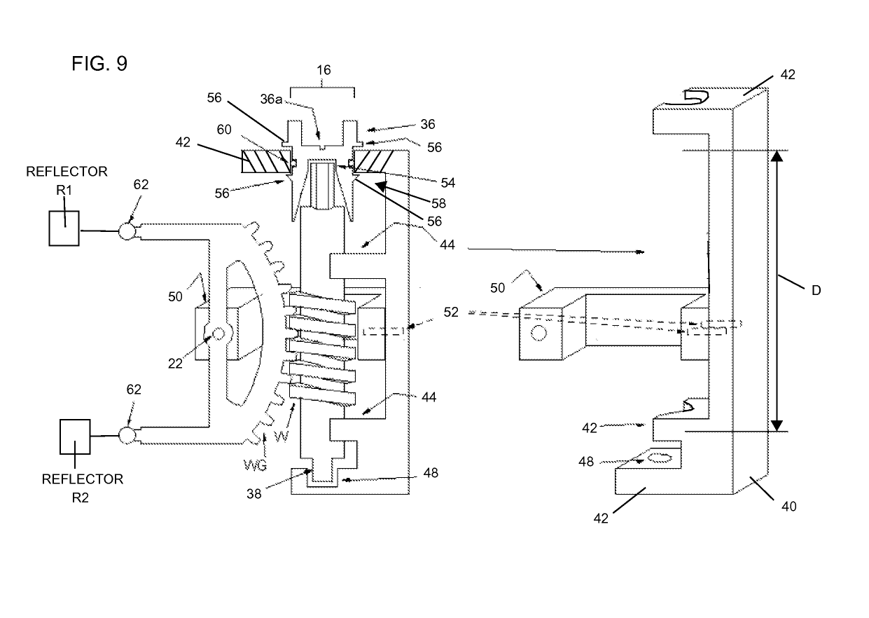

FIG. 8 shows the control rod 28 which carries the worm or driving gear W. The control rod 28 is elastic or flexible, as explained above. It contains a hex nut 34 on one end 28a (FIG. 8) which mates with at least one sealed adjusting cap 36 (FIG. 9) and described later. The control rod 28 also contains a boss 38 at end 28b (FIG. 8) in FIGS. 8 and 9 and described below.

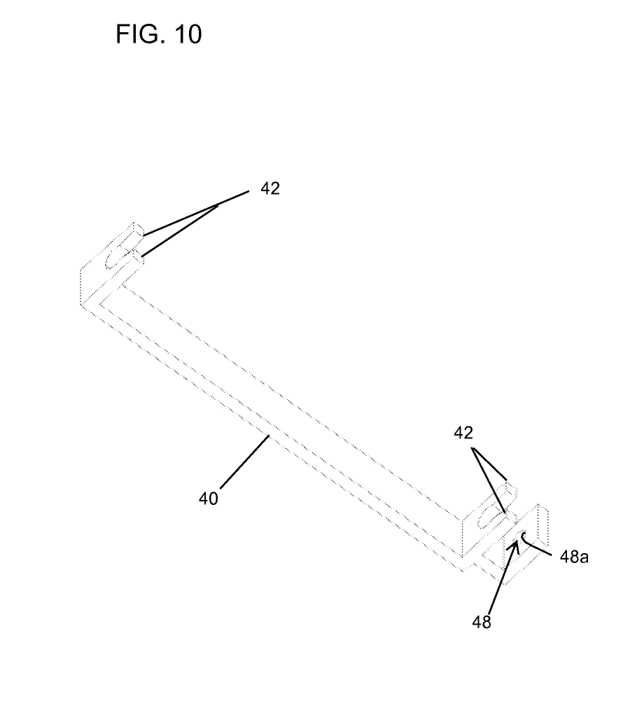

FIGS. 2, 6-7 and 9-10 show a simplified view of a support or housing 40 adapted to rotatably receive and support the control rod 28. In FIG. 10, the housing 40 contains two receiving brackets or forks 42. These act as cradles 44 in FIG. 9 to support the control rod 28. The control rod 28 in FIG. 10 also contains a boss 38 extending from a shoulder 46 which fits into a bore 48 defined by a wall 48a in FIG. 9.

FIG. 9 shows another embodiment of the control rod 28 as inserted into the housing 40. The image on the right side of the FIG. 9 shows the housing 40 exploded away from the worm gear or driven gear WG and without the control rod 28 so that features of the housing 40 may be shown. A generally U-shaped bracket 50 shown on the right side is integrally formed in or conventionally fastened to the housing 40 by a weld, screws, bolts or pins 52. In the illustration, the bolts or pins 52 are shown, and they also prevent rotation of the U-shaped bracket 50.

The boss 38 of the control rod 28 is captured in the bore 48 (FIG. 10). The hex nut 34 of the control rod 28 is captured in the at least one sealed adjusting cap 36 which contains a hex socket 54 which mates with the hex nut 34. The at least one sealed adjusting cap 36 carries barbs 56 which allow the at least one sealed adjusting cap 36 to removably snap into an aperture 58 in the housing 40. An O-ring 60 seals the at least one sealed adjusting cap 36 to prevent the entry of unwanted moisture and dirt. The at least one sealed adjusting cap 36 contains a slot 36a which allows a screwdriver to rotate the control rod 28 which in turn rotates the worm gear or driven gear WG. The slot 36a can also be taken to represent a slot for a Phillips head screwdriver or an Allen wrench.

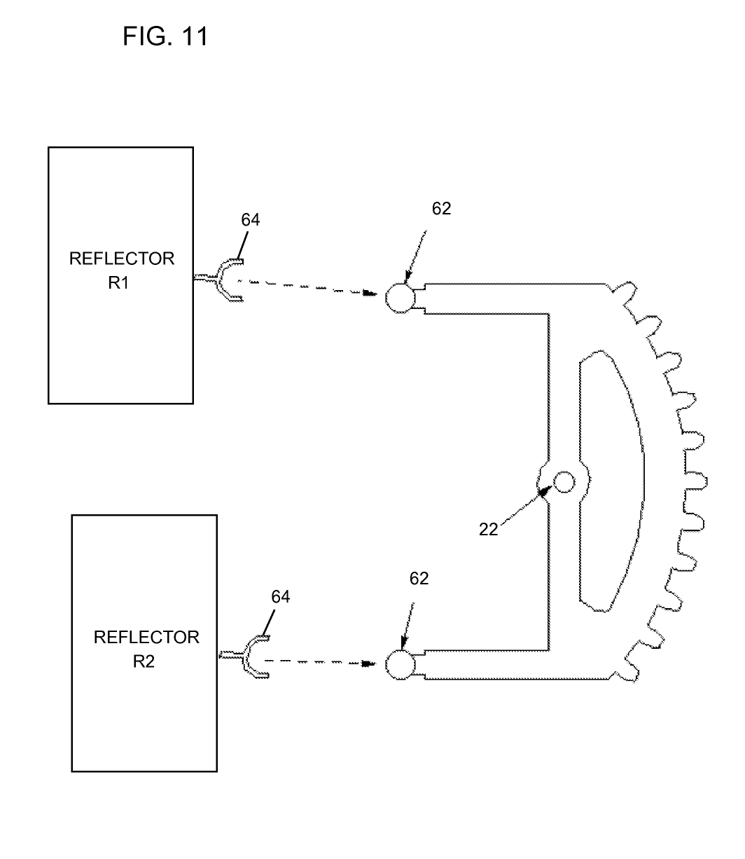

In one alternate embodiment shown in FIGS. 9 and 11, the worm gear or driven gear WG can support balls 62, two of which are shown. In FIG. 11, these balls 62 can engage with mating sockets 64 (FIG. 11) fastened to lamps or reflectors R1, R2. The pair of balls 62 allow adjustment of two reflectors R1, R2 simultaneously.

### Additional Considerations

1. The rotation of the worm or driving gear W causes rotation of the worm gear or driven gear WG. When the worm gear or driven gear WG strikes its travel limit, such as point P in FIG. 2, the load on the worm or driving gear W increases significantly. This creates a radial force which pushes against the worm or driving gear W, thus disengaging the worm or driving gear W from the worm gear or driven gear WG. This disengagement can be visualized by reference to two spur gears 66 and 68 in FIG. 13.

Spur gear 66 is the driving gear and spur gear 68 is the driven gear in the example. The gear teeth make contact at point P1. Because of the shapes of the teeth, point P1 is, in effect, residing on an inclined plane or cam surface. The torque applied to the driven spur gear 68 causes forces indicated by arrows A1 and A2, which tends to separate the spur gears 66 and 68.

A worm or driving gear—worm gear or driven gear system can encounter a similar force because the cross-sectional shape of the worm or driving gear W in the region where it contacts the worm gear or driven gear WG is somewhat similar to that of spur gear 66. Of course, this is a simplified explanation, and more detailed explanations are possible.

2. The discussion above considered rotation of the reflector 18 in FIG. 2. However, the light source 20 can also be rotated directly by the worm gear or driven gear WG. Since the reflector 18 projects light from the motor vehicle 10, it can also be considered a light source 20, so that rotation of reflector 18 amounts of rotation of a light source 20.

3. In another embodiment, the control rod 28 can be flexible and the worm or driving gear W can be rigid. For example, the control rod 28 can be constructed of nylon, and the worm or driving gear W can be constructed of brass. Alternately, the control rod 28 and the worm or driving gear W can be constructed of the same material, such as flexible nylon or plastic. As another alternate and as mentioned earlier, the control rod 28 and the worm or driving gear W can be a single integral component, as would occur if both were injection-molded of nylon in one piece.

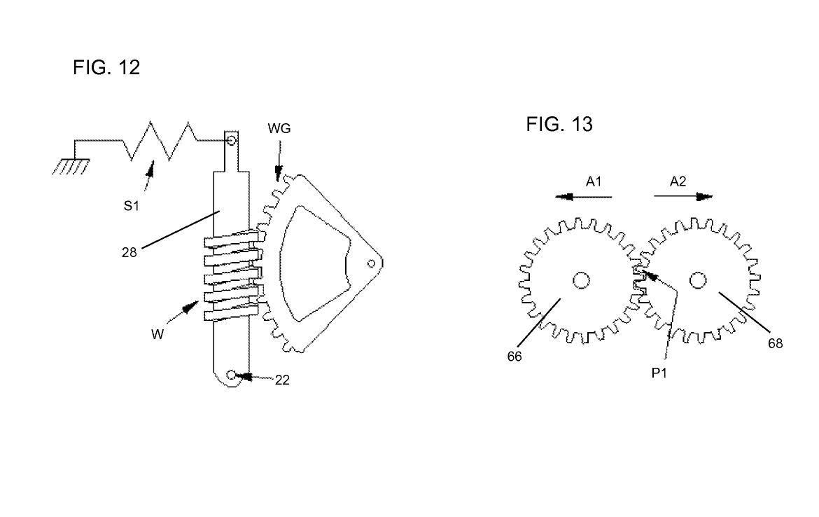

4. The preceding discussion assumed that the control rod 28 flexed when the abutment at point P in FIG. 2 occurred to thereby disengage the worm or driving gear W from the worm gear or driven gear WG. In another form of the invention, the control rod 28 is rigid and it, together with the worm or driving gear W, become displaced when this abutment is reached. For example, in FIG. 12, the control rod 28 is rotatable about point PA. A spring 70 holds the worm or driving gear W against the worm gear or driven gear WG. When the worm gear or driven gear WG reaches its limit of travel, the worm or driving gear W is pushed out of engagement and the spring 70 compresses.

Pivoting of the control rod 28 is shown. Instead, the displacement of the worm or driving gear W can occur by allowing the control rod 28 to slide on rails or rods under the bias of spring 70.

5. The gear train comprising worm or driving gear W and worm gear or driven gear WG transfers motion in one direction, namely, from the worm or driving gear W to the worm gear or driven gear WG. Motion is not transferred in the other direction, from the worm gear or driven gear WG to the worm or driving gear W, and this is a standard feature of many worm drives.

Consequently, the worm or driving gear W serves to hold the worm gear or driven gear WG in a fixed position once rotation of the worm or driving gear W drives the worm gear or driven gear WG into that position.

When the disengagement of FIG. 7 occurs, the worm gear or driven gear WG becomes somewhat free to rotate and thus the reflector 18 may move at this time. However, that rotation can continue for only, at most, one tooth spacing of the worm gear or driven gear WG because then the worm or driving gear W will immediately reengage with the worm gear or driven gear WG and lock the worm gear or driven gear WG in place.

6. From one perspective, the gear train identified and discussed relative to FIGS. 2-7 performs three functions. One, rotation of the worm or driving gear W drives the worm gear or driven gear WG into a selected position. Two, the worm or driving gear W holds the worm gear or driven gear WG in that position. Three, the worm or driving gear W acts as a clutch when rotation of the worm causes the worm gear or driven gear WG to reach a limit or otherwise strike an obstacle.

7. The clutching rod adjuster disclosed can be used with embodiments such as those disclosed in U.S. Patent Application. 2014/0003080 (King) filed Jun. 29, 2012, or one of the present inventor's co-pending applications, such as U.S. Ser. No. 13/558,720, filed Jul. 26, 2012, entitled “Multiple Lamp Element Adjuster for a Vehicle.” These are both hereby incorporated herein by reference and made a part hereof.

8. In one form of the invention, the disengagement of the worm or driving gear W occurs at a specific torque value in order not to damage the head lamp adjustment device when it is in a bind or at a mechanical limit. This torque value is frequently requested in specifications issued by car makers to lamp set makers and the device is engineered to meet these limits. The “clutching rod headlamp adjuster” utilizes a rod 28 that is typically made from a plastic, such as a grade of nylon, that had a defined bending tolerance when engaging an adjuster system. When the headlamp adjustment exceeds the specified torque, the amount of bend or deflection in the rod 28 will be that required to “clutch’ and not further adjust the lamp.

9. The control rod 28 does not require a circular cross-section, e.g., it could have a square or polygonal cross section, but for convenience can he referred to as a rod. It is contemplated that the control rod 28 has any convenient cross-sectional shape and supported length that is suitable. The control rod 28 has a designed pitched thread incorporated in the shaft and the adjusting device will have the matching gear-styled threads that perform the adjustment. The matching threads can be provided on the rotating adjuster as shown in the figures or be incorporated on the reflector 18 to further reduce part count.

10. The depicted clutching rod headlamp adjuster includes three components: clutching adjustment rod 28, adjusting gear WG and at least one sealed adjusting cap 36. These can be made of a low cost plastics material. The clutching adjustment rod 28 is rotatably disposed in a headlamp housing, trapped in a designed channel that holds the rod so it can rotate. The upper and lower pivotal support regions will be set at a specific distance between two imaginary points along the longitudinal axis of the control rod 28, this distance being indicated as D in FIG. 9.

The distance between the trapped end and the adjusting gear and the amount of thread engagement will be used to calculate the amount of the flex the adjusting control rod 28 tends to undergo in order to give the proper clutching torque value required to meet a specification. The flex will be considered when choosing the material of which to make the control rod 28. The flex of the control rod 28 is a result of the materials modulus of elasticity and the moment of inertia of the cross-sectional shape of the control rod 28.

11. The headlamp housing is designed with two attachment points for pivotal bearings at a calculated value for the mounting of the clutching rod headlamp adjuster. The geared adjusting pivot mating cooperates with the clutching adjustment rod thread pitch at a designed distance from the fixed end of the adjusting rod. The geared adjusting pivot is mounted to or in relationship to the housing so that it can be attaching to the movable optical elements. The clutching adjustment rod contains a thread that matches the pivotally mounted rotating adjustment gear. The clutching adjustment rod 28 rotates so as to adjust the optical elements, e.g., the reflector 18 or light source itself. The clutching adjustment rod 28 is made of a material that consistently provides a nominal flex when in an over-torque situation. The geared adjusting pivot can be designed to align one or more than one optical element during rotation of the clutching adjustment rod.

12. The at least one sealed adjusting cap 36 illustrated in the figures simplifies assembly and reduces or eliminates the need for a right-angle adjusting gear and this is expected to reduce cost of the assembly. The use of the at least one sealed adjusting cap 36 facilitates adjusting multiple optical elements simultaneously. The at least one sealed adjusting cap 36 snaps into the top of the headlamp housing providing an engagement to the adjusting rod 28 that allows it to spin, while providing an adjustment location on the outside of the headlamp that is serviceable by the car-maker during assembly of the headlamp and also by the ultimate end consumer vehicle operator for maintenance. Headlamps that lack an internal moveable optical system would not require the at least one sealed adjusting cap 36.

This invention, including all embodiments shown and described herein, could be used alone or together and/or in combination with one or more of the features covered by one or more of the claims set forth herein, including but not limited to one or more of the features or steps mentioned in the Summary of the Invention and the claims.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. An apparatus for aiming a lighting device in a vehicle, comprising:
a gear which is affixed to a source of light and alters direction of said light when it rotates; and
a worm or driving gear which
engages said gear and causes said gear to rotate when said worm or driving gear rotates; and
disengages from said gear and does not cause said gear to rotate when said gear reaches a limit of rotation.

2. The apparatus according to claim 1 wherein said source of light comprises a reflector which receives light from an illuminator which comprises at least one light-emitting diode.

3. The apparatus according to claim 1 wherein said source of light comprises an illuminator which comprises a plurality of light-emitting diodes.

4. The apparatus according to claim 1 wherein said worm or driving gear is elastic and flexible.

5. The apparatus according to claim 4 wherein said worm or driving gear is made of plastic.

6. The apparatus according to claim 1 wherein the lighting device is a headlamp having a reflector coupled to or integral with said gear and that moves in response thereto.

7. The apparatus according to claim 1 wherein said worm or driving gear is elastic and deforms to cause said disengagement from said gear.

8. The apparatus according to claim 1 wherein said apparatus further comprises a support bracket for rotatably supporting said worm or driving gear in operative relationship to said gear.

9. A vehicle lighting device adjuster which adjusts an optical axis of light projected by a light source in a vehicle lighting device comprising:
a) a worm gear or driven gear which, when rotated, alters the optical axis of light; and
b) a worm or driving gear which
i) rotates said worm gear or driven gear and
ii) holds said worm gear or driven gear in a selected position and
iii) acts as a clutch when said worm gear or driven gear reaches a travel limit.

10. The vehicle lighting device adjuster according to claim 9 wherein said worm or driving gear acts as a clutch by deforming or being deflected out of engagement with said worm gear or driven gear.

11. The vehicle lighting device adjuster according to claim 9 and further comprising a rod which supports said worm or driving gear and which bends or deforms when said worm gear or driven gear reaches said travel limit, to thereby disengage said worm or driving gear from said worm gear or driven gear.

12. The vehicle lighting device adjuster according to claim 9 and further comprising a reflector attached to said worm gear or driven gear for reflecting light along the optical axis.

13. The vehicle lighting device adjuster according to claim 9 wherein said worm or driving gear is elastic and flexible.

14. The vehicle lighting device adjuster according to claim 13 wherein said worm or driving gear is made of plastic.

15. A vehicle lighting device adjuster which adjusts optical axis of light projected by a light source comprising:
a) a reflector which receives the light and projects the light from a vehicle along the optical axis;
b) an adjustment bracket which supports said reflector;
c) a rotatable worm gear or driven gear which supports said adjustment bracket to thereby rotate said reflector when said worm gear or driven gear rotates;
d) a worm or driving gear which drives said worm gear or driven gear; and
e) a flexible shaft which supports said worm or driving gear and which draws said worm or driving gear out of engagement when loading imposed by said worm gear or driven gear exceeds a predetermined limit.

16. The vehicle lighting device adjuster according to claim 15 wherein said loading exceeds said predetermined limit when said worm gear or driven gear is obstructed from further movement.

17. The vehicle lighting device adjuster according to claim 15 wherein said worm or driving gear is elastic and flexible.

18. The vehicle lighting device adjuster according to claim 15 wherein said worm or driving gear is made of plastic.

19. A vehicle lighting device comprising:
an adjuster which adjusts an optical axis of light projected by a light source comprising:
a reflector which receives the light and projects the light from a vehicle along said optical axis, said adjuster comprising:
an adjustment housing which supports said reflector;
a driven gear which drives said adjustment housing to change a position of said reflector when said driven gear rotates;
a driving gear which drives said driven gear;
a flexible shaft which supports said driving gear and which draws said driving gear out of engagement when loading imposed by said driven gear exceeds a predetermined limit; and
at least one adjustable sealing cap detachably coupled to said adjustment housing and engaging said flexible shaft and allowing it to spin, while providing an adjustment location on the outside of the vehicle lighting device.

20. The vehicle lighting device according to claim 19 wherein said adjustment housing comprises an aperture and said at least one adjustable sealing cap is removeably snap fit into said aperture.

21. The vehicle lighting device according to claim 19 wherein said flexible shaft comprises an end that is captured in said at least one adjustable sealing cap after said at least one adjustable sealing cap is detachably securing to said adjustment housing.

22. The vehicle lighting device according to claim 19 wherein said at least one adjustable sealing cap comprises a slot or aperture that allows a tool to be inserted therethrough and engage a tool-engaging end of said flexible shaft in order to rotate said driving gear which, in turn, drives said driven gear.
